(19) United States
(12) Patent Application Publication
(10) Pub. No.: US 2009/0109916 A1
(43) Pub. Date: Apr. 30, 2009

(54) METHOD AND APPARATUS FOR PROVIDING A SHARED RESERVATION ACKNOWLEDGEMENT CHANNEL

(75) Inventors: Heikki Berg, Viiala (FI); Jarkko Kneckt, Espoo (FI)

Correspondence Address: DITTHAVONG MORI & STEINER, P.C., 918 Prince St., Alexandria, VA, 22314, US

(73) Assignee: Nokia Corporation, Espoo (FI)

(21) Appl. No.: 12/263,014

(22) Filed: Oct. 31, 2008

Related U.S. Application Data
(60) Provisional application No. 60/984,182, filed on Oct. 31, 2007.

(51) Int. Cl. H04W 28/16

(52) U.S. Cl. 370/329

(57) ABSTRACT

An approach is provided for resource allocation within a network. A request is generated for resource allocation from a neighboring node within a network. The request is inserted in a beaconing subframe of a transmission frame. The transmission frame includes a reservation subframe that provides acknowledgement signaling relating to a grant of the resource allocation.

### RELATED APPLICATIONS

This application claims the benefit of the earlier filing date under 35 U.S.C. 119(e) of U.S. Provisional Application Ser. No. 60/984,182 filed Oct. 31, 2007, entitled “Method and Apparatus for Providing a Shared Reservation Acknowledgement Channel,” the entirety of which is incorporated herein by reference.

### BACKGROUND

Radio communication systems, such as a wireless data networks (e.g., spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves resource allocation of network resources among network nodes. Traditional approaches utilize handshake mechanisms that introduce delay, thereby negatively impacting network performance.

### SOME EXEMPLARY EMBODIMENTS

Therefore, there is a need for an approach for providing an efficient resource allocation scheme, which can co-exist with already developed standards and protocols.

According to one embodiment, a method comprises generating a request for resource allocation from a neighboring node within a network. The method also comprises inserting the request in a beaconing subframe of a transmission frame. The transmission frame includes a reservation subframe that provides acknowledgement signaling relating to a grant of the resource allocation.

According to another embodiment, an apparatus comprises a resource allocation module configured to generate a request for resource allocation from a neighboring node within a network, and to insert the request in a beaconing subframe of a transmission frame. The transmission frame includes a reservation subframe that provides acknowledgement signaling relating to a grant of the resource allocation.

According to another embodiment, a method comprises receiving a request from a neighboring node within a network for resource allocation, wherein the request is transmitted within a beaconing subframe of a transmission frame that includes a reservation subframe. The method also comprises granting or rejecting the request using the reservation subframe to indicate an acknowledgement or negative acknowledgement relating to the grant or the rejection. The reservation subframe includes a plurality of signaling opportunities for specifying the acknowledgement or the negative acknowledgement, and the signaling opportunities are further used to relay an acknowledgement or negative acknowledgement from another neighboring node.

According to yet an exemplary embodiment, an apparatus comprises a resource allocation module configured to receive a request from a neighboring node within a network for resource allocation, wherein the request is transmitted within a beaconing subframe of a transmission frame that includes a reservation subframe. The resource allocation module is further configured to grant or reject the request using the reservation subframe to indicate an acknowledgement or negative acknowledgement relating to the grant or the rejection. The reservation subframe includes a plurality of signaling opportunities for specifying the acknowledgement or the negative acknowledgement, and the signaling opportunities are further used to relay an acknowledgement or negative acknowledgement from another neighboring node.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of a communication system capable of providing a shared medium reservation acknowledgement channel (SMRA) to support resource reservation, according to various exemplary embodiments of the invention;

FIG. 2 is a flowchart of a resource reservation process, according to various exemplary embodiments;

FIG. 3 is a diagram of a mesh network capable of providing a shared medium reservation acknowledgement channel scheme, according to various embodiments of the invention;

FIGS. 4A and 4B are diagrams of schemes for utilizing SMRA opportunities, according to various exemplary embodiments;

FIG. 5 is a diagram of an exemplary three-way-handshake process for resource reservation;

FIG. 6 is a diagram of an exemplary MAC (Medium Access Control) frame structure;

FIGS. 7A and 7B are, respectively, a diagram of a beaconing subframe and a ladder diagram in which the beaconing subframe is used to provide resource reservation, according to various exemplary embodiments;

FIGS. 8A-8E are, correspondingly, is a diagram of a shared medium reservation acknowledgement subframe, and ladder diagrams in which the subframe is used to provide resource reservation, according to various exemplary embodiments;

FIG. 9 is a diagram of hardware that can be used to implement an embodiment of the invention;

FIGS. 10A and 10B are diagrams of an exemplary WiMAX (Worldwide Interoperability for Microwave Access) architecture, in which the system of FIG. 1 can operate, according to various exemplary embodiments of the invention; and

FIG. 11 is a diagram of exemplary components of a user terminal, according to an embodiment of the invention.

### DETAILED DESCRIPTION

An apparatus, method, and software for providing resource allocation are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

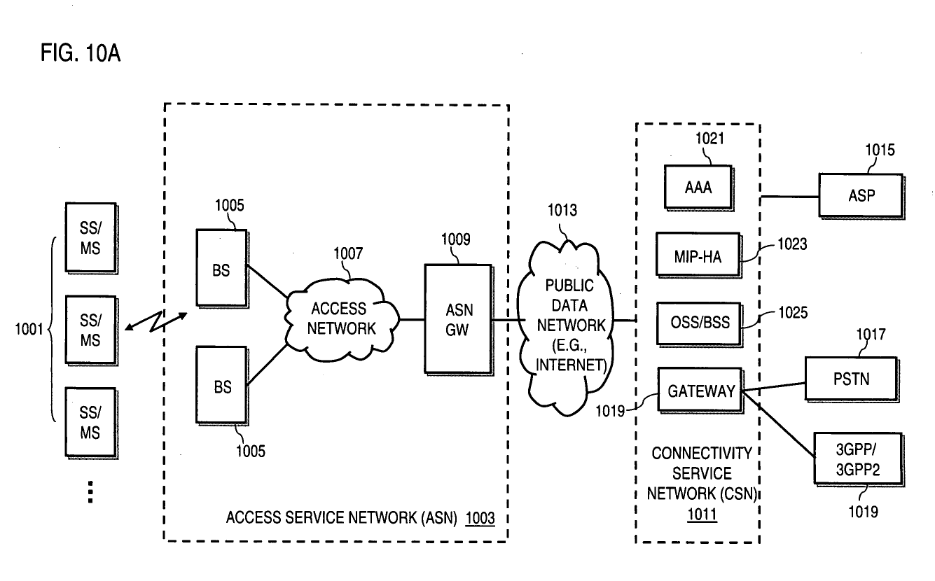

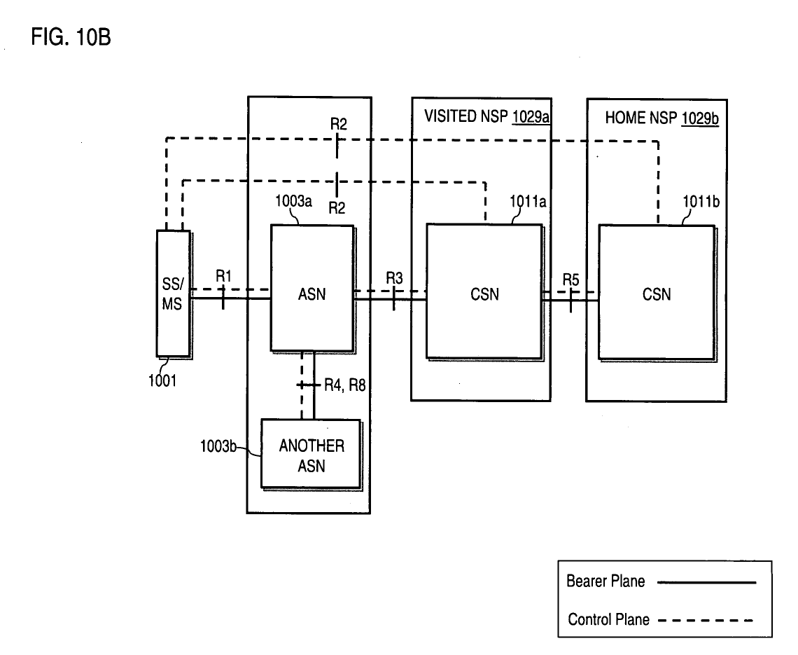

Although the embodiments of the invention are discussed with respect to UWB (Ultra WideBand) type and Institute of Electrical & Electronics Engineers (IEEE) 802.16 mesh option type of beaconing, it is recognized by one of ordinary skill in the art that the embodiments of the inventions have applicability to other equivalent framing structures, topologies, and systems (e.g., NextG (Next Generation) mesh radio system, WiMAX (Worldwide Interoperability for Microwave Access) of FIGS. 10A and 10B, etc.).

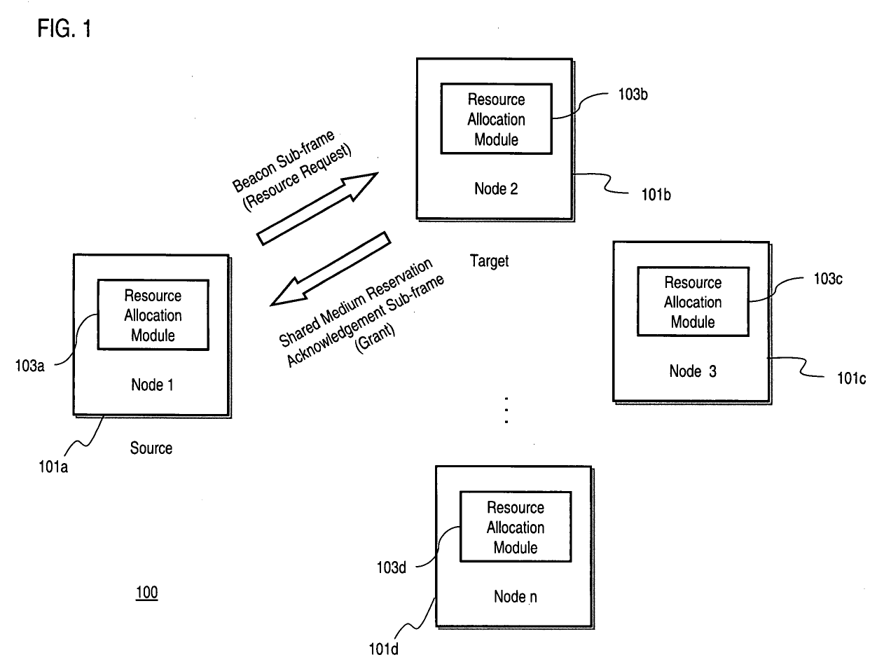

FIG. 1 is a diagram of a communication system capable of providing a shared medium reservation acknowledgement channel (SMRA) to support resource reservation, according to various exemplary embodiments of the invention. As shown, a communication system 100 includes multiple nodes 101a-101n, Nodes 1 . . . n, which can communicate to allocate resources with each other through respective resource allocation modules (or logic) 103a-103n. For instance, Node 1 requests resource reservation by transmitting a resource request within its beacon opportunity. Based on the information in resource request, the surrounding (e.g., neighboring) nodes can either grant the resource as requested, grant the resource request with restrictions (partial grant) or reject the resource request. Thus, Node 2, as the target node, can determine whether to grant the request.

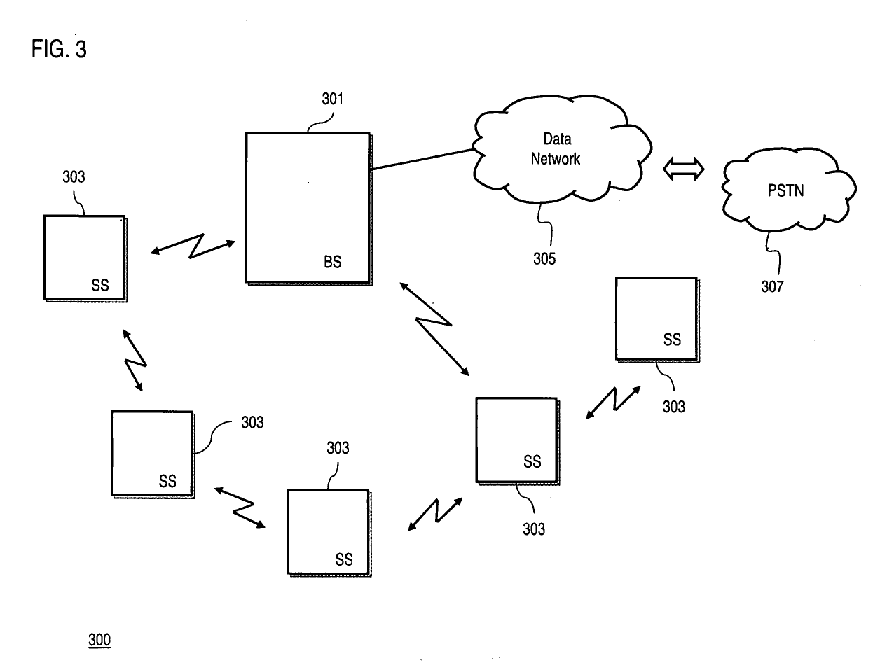

The nodes 101 can be any type of network element, such as user equipment (UE), handsets, terminals, mobile stations, base stations, units, devices, or any type of interface to the user (such as “wearable” circuitry, etc.). By way of example, one of the nodes (e.g., node 101a) is a user equipment or subscriber station (SS) and one of the nodes is a base station (e.g., node 101b); these nodes 101 can communicate according to an air interface defined by IEEE 802.16, for example. In one embodiment, the nodes are arranged according to a mesh topology, as shown in FIG. 3.

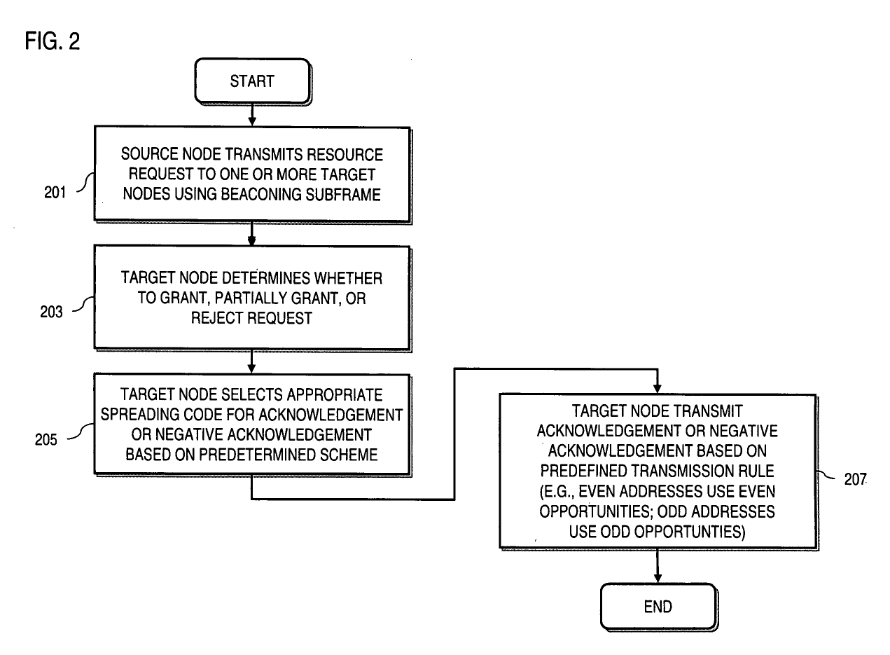

FIG. 2 is a flowchart of a resource reservation process, according to various exemplary embodiments. The system of FIG. 1, according to certain embodiments, minimizes such delay and provides greater flexibility in resource reservation mechanisms, as next explained. Under this scenario, a shared medium reservation acknowledge (SMRA) subchannel is introduced in the system 100 within a transmission frame (e.g., a MAC frame). In step 201, source node 101a transmits a resource request to one or more target nodes (e.g., node 101b-101d) using a beacon subframe within a transmission frame. Assuming node 101b is the target node, node 101b upon receipt of the request, determines whether to grant, partially grant, or reject request, as in step 203. By way of example, Node 1 acts as a source node and transmits a resource request to one or more target nodes using the beaconing subframe.

In step 205, the target node 101b selects an appropriate spreading code to signify an acknowledgement or a negative acknowledgement based on a predetermined scheme. According to certain embodiments, the following schemes can be employed to determine the spreading code. For instance, the beacon transmission order can be used to assign the spreading code. Also, the original request can specify explicitly the spreading code. Further, the spreading code can be determined based on some information in the request; this information can include, e.g., source node number, target node number, message number, etc.

Thereafter, the target node 101b transmits an acknowledgement signal (either an acknowledgement message or a negative acknowledgement message) based on a predefined transmission rule. In one embodiment, the rule can specify that a node having an even address (e.g., MAC address) transmits using an even transmission opportunity or slot, while an odd address utilizes odd opportunities (step 207). It is contemplated any variation on manipulating the unique addresses and transmission opportunities can be employed.

The above approach can be deployed in, for example, a radio network having a meshed topology.

FIG. 3 is a diagram of a mesh network capable of providing a shared medium reservation acknowledgement channel scheme, according to various embodiments of the invention. A mesh network 300 (e.g., IEEE 802.16 network) includes a base station (BS) 301 and multiple subscriber stations (SSs) 303. The BS 301 serves as a gateway for the SSs 101 to external networks 305, 307, while each of the SS 101 can serve as an access point to such networks 305, 307. Such networks 305, 307 can include a data network 305, which can be part of the global Internet, for instance. Also, the data network 305 can interface with a telephony network, such as a Public Switched Telephone Network (PSTN) 307.

Under IEEE 802.16, the system 300 supports two modes of operation: Point-to-Multipoint (PMP) mode and mesh mode. In PMP, each SS 303 directly communicates with the BS 301 through a single-hop link. In the mesh mode, however, the SSs 303 can communicate with the mesh BS 301 and with other SSs 303 via multi-hop routes through the other SSs 303. This mesh topology provides high network reliability and availability.

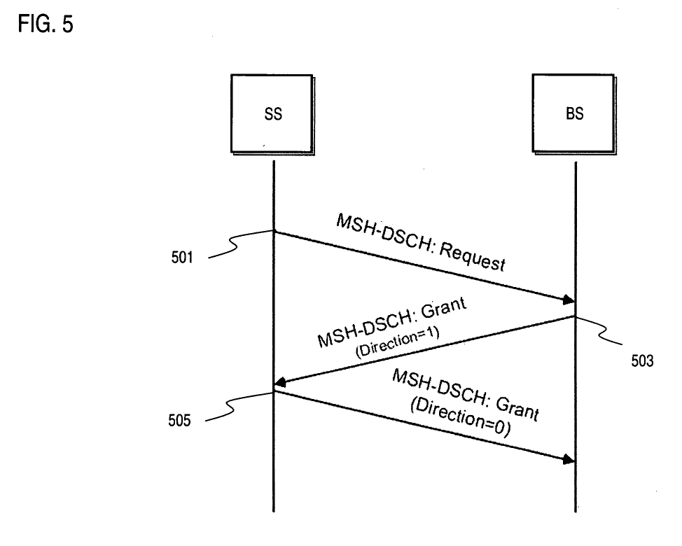

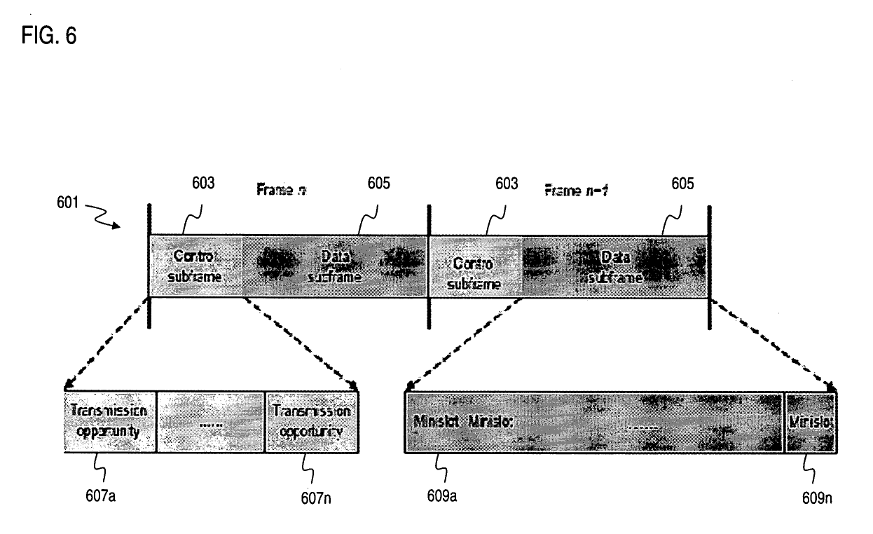

In IEEE 802.16 mesh node, both centralized scheduling and distributed scheduling are supported. Mesh centralized Schedule (MSH-CSCH) and Mesh Distributed Scheduling (MSH-DSCH) messages are exchanged in the scheduling control subframe to assign the data minislots to different stations (as shown in FIG. 6). The number of transmission opportunities for MSH-CSCH and MSH-DSCH in each scheduling control subframe are network parameters that can be configured. Centralized scheduling is mainly used to transfer data between the mesh BS 301 and the SSs 303, while distributed scheduling targets data delivery between SSs 303 within mesh network 300. The centralized scheduling handles both the uplink (transmission from SSs 303 to BS 301), and downlink (from BS 301 to SSs 303). In the mesh node, Time Division Duplex (TDD) is used, in one embodiment, to share the channel between the uplink and downlink. In distributed scheduling, the SSs 303 are peers, and thus, compete for transmission opportunities. As described, this competition for resources traditionally involve a three-way handshaking procedure (shown in FIG. 5) to reserve transmission opportunities for exchanging data between neighboring SSs. It is noted that this handshake procedure introduces delay before data can be exchanged.

Although the network 300 is described with respect to a meshed topology, it is contemplated that other topologies may be deployed.

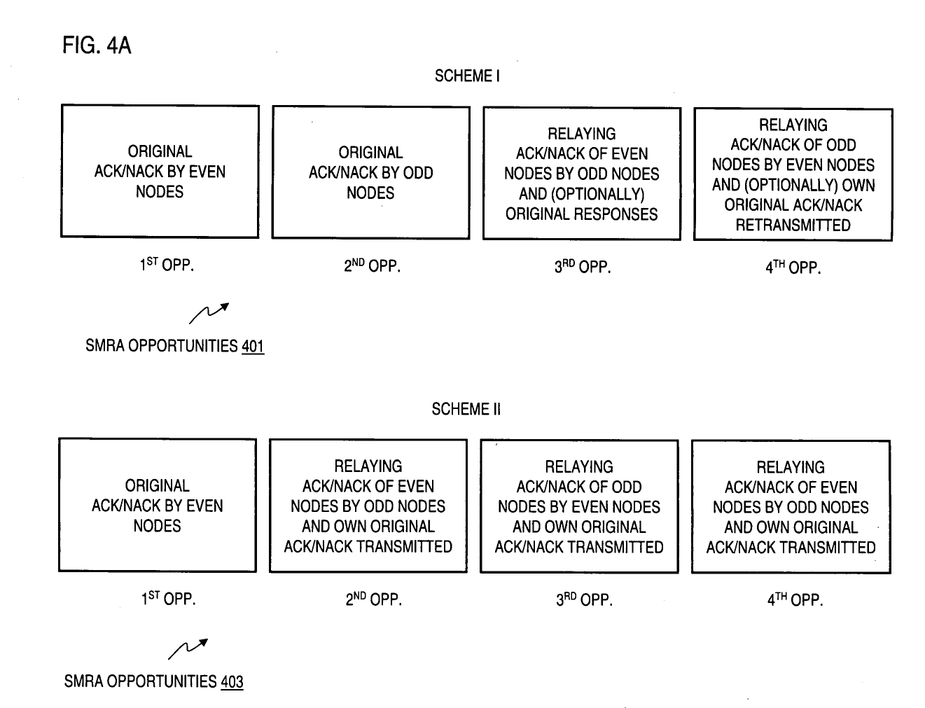

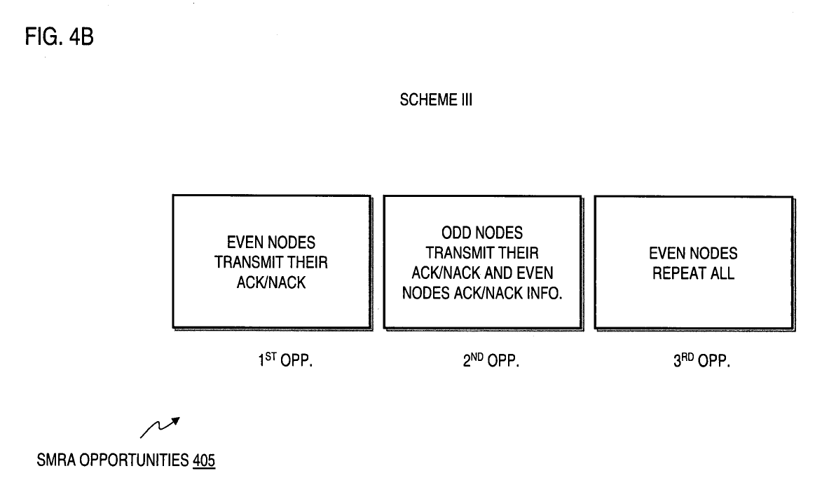

FIGS. 4A and 4B are diagrams of schemes for utilizing SMRA opportunities, according to various exemplary embodiments. As seen in FIGS. 4A and 4B, schemes I-III provide opportunities 401, 403, and 405 based on addressing of the nodes 101. Specifically, the SMRA opportunities are used as shown below in Table 1:

TABLE 1

| | |
|---|---|
| Scheme I | 1. First SMRA opportunity is used for original ACK/NACK |
| | codes by even nodes |
| | 2. Second SMRA opportunity is used for original |
| | ACK/NACK codes by odd nodes |
| | 3. Third SMRA opportunity is used for relaying ACK/NACK |
| | codes of even nodes by odd nodes and (possibly) their own |
| | original responses as transmitted in first SMRA response |
| | 4. Fourth SMRA opportunity is used for relaying ACK/NACK |
| | codes of odd nodes by even nodes and (possibly) their own |
| | original ACK/NACK codes are retransmitted |
| Scheme II | 1. First SMRA opportunity is used for original |
| | ACK/NACK codes by even nodes |
| | 2. Second SMRA opportunity is used for relaying |
| | ACK/NACK codes of even nodes by odd nodes and |
| | own original ACK/NACK codes are transmitted also. |
| | 3. Third SMRA opportunity is used for relaying ACK/NACK |
| | codes of odd nodes by even nodes and own original |
| | ACK/NACK codes are transmitted also. |
| | 4. Fourth SMRA opportunity is used for relaying ACK/NACK |
| | codes of even nodes by odd nodes and own original |
| | ACK/NACK codes are transmitted also. This basically |
| | repeats step 2. |
| Scheme | 1. Even nodes transmit their ACK/NACK |
| III | 2. Odd nodes transmit their ACK/NACK and even nodes |
| | ACK/NACK info. |
| | 3. Even nodes repeat all information. This mechanism uses |
| | only 3 slots. |

The difference between the above schemes involves the time a node 101 has to decode the message (while receiving) before the nodes 101 need to relay detected codes. Among the three mechanisms, scheme I provides more time for processing.

Because 1-hop neighbors can decode each others beacon transmissions, these nodes 101 can calculate which spreading codes are used in their neighborhood for positive and negative acknowledgements. When a node is listening in a SMRA opportunity, the node monitors for set of known spreading codes for positive and negative ACK messages. If the node 101 detects any of the monitored spreading, the node repeats those codes in its own SMRA opportunity together with the codes it has decided to transmit.

FIG. 5 is a diagram of an exemplary three-way-handshake process for resource reservation. This process, e.g., IEEE 802.16 procedure, defines a three-way handshake mechanism that uses specific signalling messages to request, grant, and confirm available resources (bandwidth). By way of illustration, this process is explained with respect to the system 300 of FIG. 3. A transmitter, SS 303, sends a MSH-DSCH request to the BS 301, per step 501. After receiving the request, the receiver, or BS 301 in this example, responds with a grant message including all or a subset of the suggested availabilities (step 503). The MSH-DSCH packet transmission is broadcasted within the neighborhood. Therefore, the neighbor nodes not included in the exchange assume the transmission takes place as granted. When the requester receives the grant messages (as in step 505), the requester replies with another grant message as a confirmation message. Thereafter, all neighbors of the requester can no longer use the allocated minislots (e.g., subframe). With this mechanism, all the neighbors of the requester, SS 303, and the granter, BS 301, can have the up-to-date subframe allocation information.

As earlier indicated, the transmission timing of these signaling messages impacts network performance. That is, if the interval between two subsequent signaling messages of a node is too large, the three-way handshake introduces delay, resulting in delayed transmission of packets in the queue. Furthermore, the BS 301 and SSs 301 will not be able to react according to frequent changes in the load of network traffic.

FIG. 6 is a diagram of an exemplary MAC (Medium Access Control) frame structure. A frame 601 includes a control subframe 603 and a data subframe 605. Each frame 601 is further divided into, e.g., 256 minislots for transmission of user data and control message. In the control subframe 603, transmission opportunities 607a-607n, which typically include multiple minislots, are used to carry signaling messages for network configuration and scheduling of data subframe minislot allocation. There are two types of control subframes: network control subframe and scheduling control subframe. As for the data frame 605, this frame provides minislots 609a-609n.

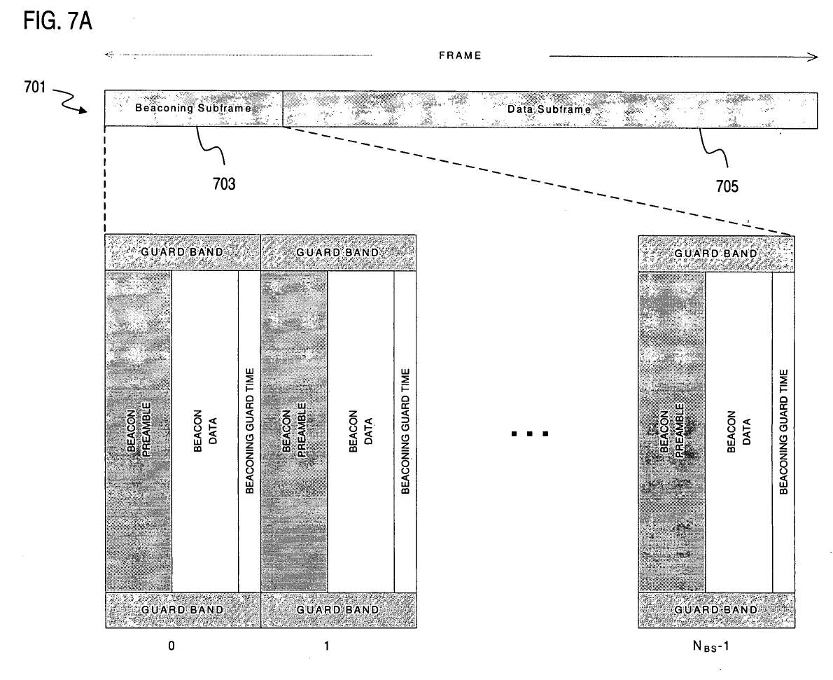

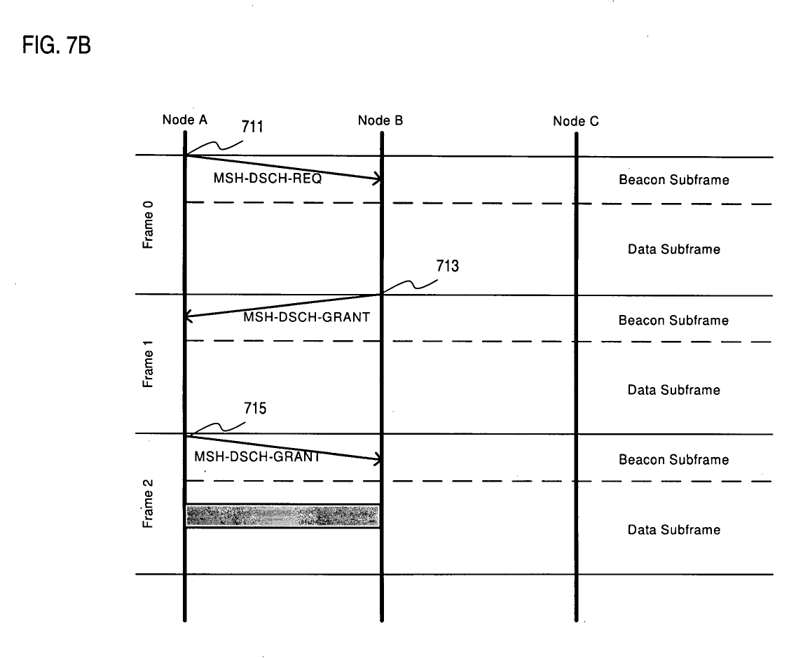

FIGS. 7A and 7B are, respectively, a diagram of a beaconing subframe and a ladder diagram in which the beaconing subframe is used to provide resource reservation, according to various exemplary embodiments. A transmission frame 701 includes a beaconing subframe 703 and a data subframe 705. The beaconing subframe 703 can include multiple slots (0 . . . N_{BS}-1), wherein each of the slots includes guard bands around a beacon preamble, beacon data, and beaconing guard time. In FIG. 7B, the described handshake procedure of FIG. 5 is implemented, wherein three transmission frames, Frame 0, Frame 1, and Frame 2, are utilized. Within the beacon subframe of Frame 0, a MSH-DSCH request is carried (step 711), while the MSH-DSCH grant message is supplied over the beacon subframe of Frame 1 (step 713). The confirmation message, MSH-DSCH grant message, is subsequently provided in the beacon subframe of Frame 2 (step 715).

To above transmission frame is modified to support acknowledgement signaling through the addition of an acknowledgement (ACK) subframe. This ACK subframe may convey a positive or negative acknowledgement message, and is more fully detailed below.

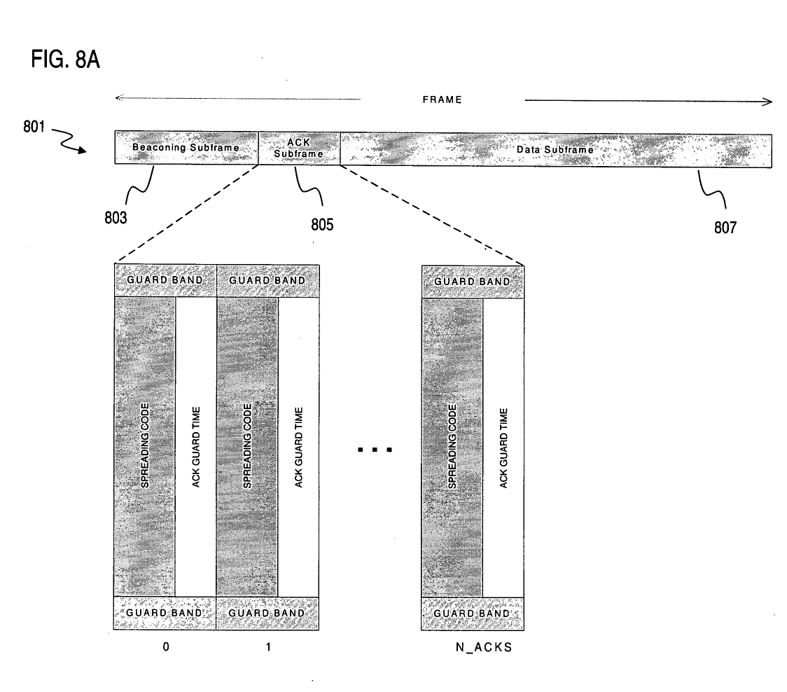

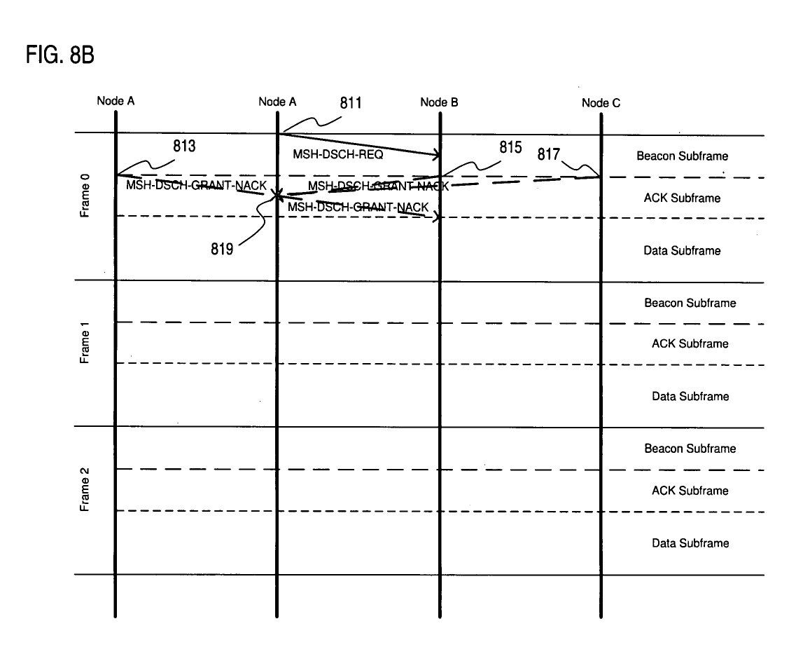

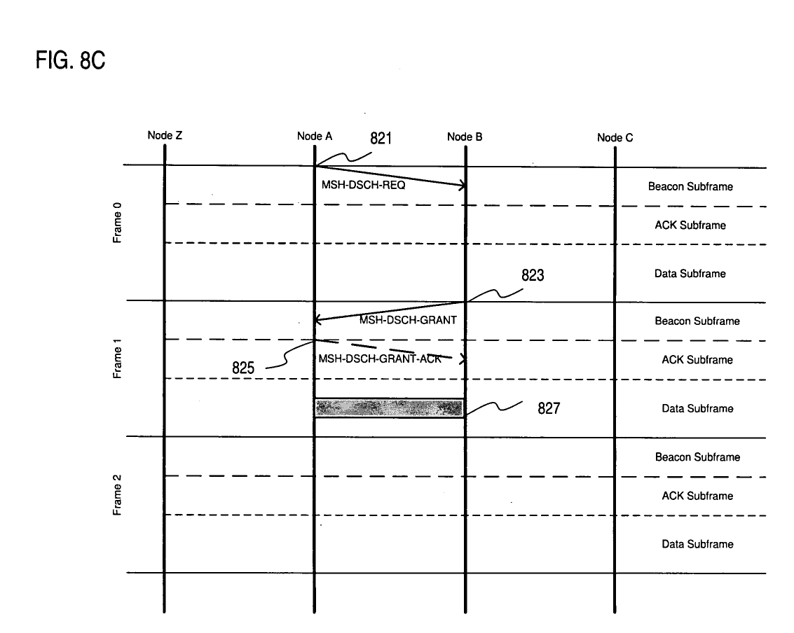

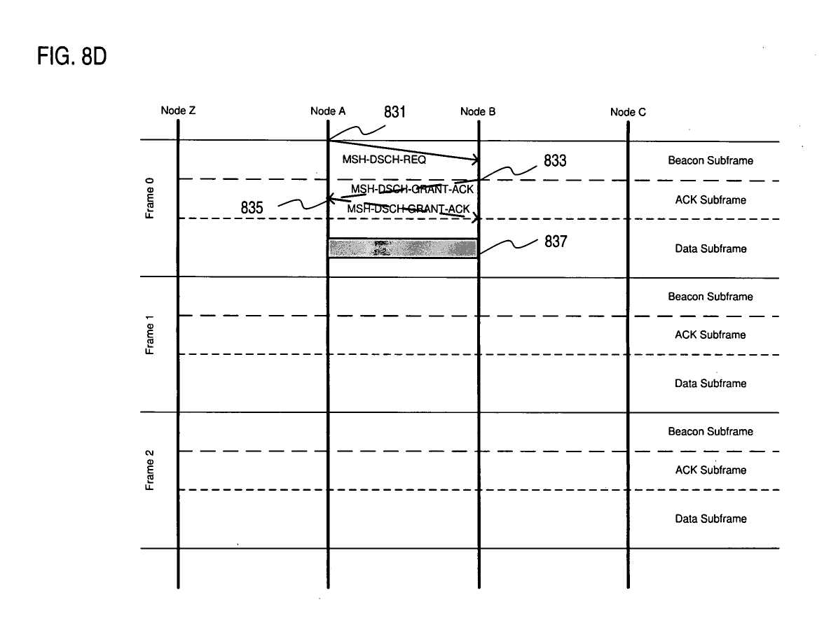

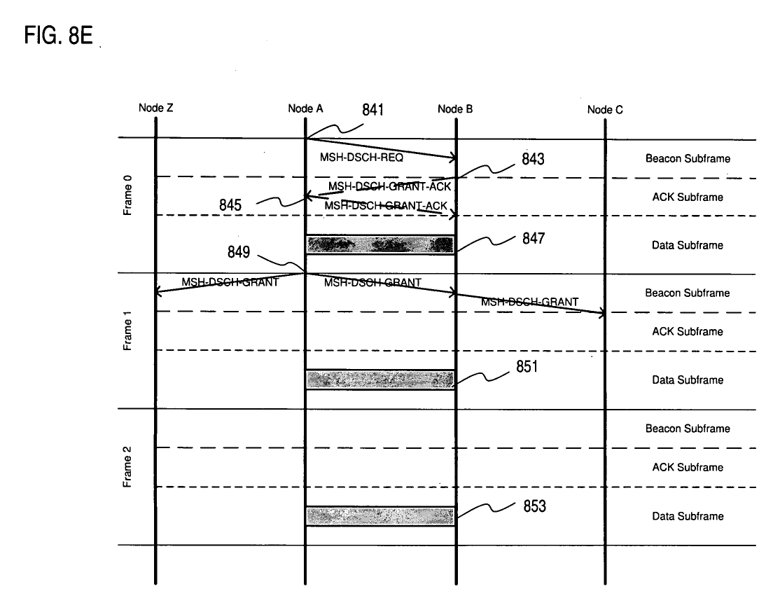

FIGS. 8A-8E are, correspondingly, is a diagram of a shared medium reservation acknowledgement subframe, and ladder diagrams in which the subframe is used to provide resource reservation, according to various exemplary embodiments. As shown in FIG. 8A, a transmission frame 801 provides a beacon subframe 803 along with a shared medium reservation acknowledgement (ACK) subframe 803 (or subchannel). A data subframe 807 can follow this ACK subframe 805. In one embodiment, the ACK subframe 805 includes multiple slots, each providing guard bands surrounding a spreading code, and an ACK guard time.

According to one embodiment, code division multiplexing (different spreading codes) is utilized to separate ACK (Acknowledgement)/NACK (Negative Acknowledgement) messages to different medium reservation requests. The identity of the transmitted ACK/NACK spreading code is unique to the resource request; and the identity can based on the information of original beacon transmission such as source node number (possibly MAC address), target node (possibly MAC address) and request number together. The shared medium reservation acknowledgement subchannel 805 provides for original transmission and relay of ACK/NACK messages.

According to one embodiment, a shared medium reservation acknowledge (SMRA) subchannel is depicted in FIG. 8A. In this example, the SMRA subframe includes at least N_ACKS (=2 ACK) opportunities; to implement ACK relaying, the number of ACK opportunities is greater, e.g., 3 or 4. It is contemplated that the number of ACK opportunities can exceed 3 or 4, depending on the implementation and desired properties of the ACK subchannel 805. According to certain embodiments, the ACK/NACK repeating mechanisms require 4 or 3 slots. In principle, there could be multiple of 4 or 3 slots ACK/NACK opportunities, if required. For instance, this is implemented if there are not enough carriers for all ACKs in the first ACK sequence.

The purpose of the multiple ACK opportunities is to reserve for each node 101 an opportunity to listen for the SMRA subchannel 805, to transmit its own ACK/NACK messages, or to relay ACK messages of the surrounding nodes 101. The spreading codes are used to separate these Boolean (ACK/NACK) messages; therefore multiple messages can be multiplexed into the same time-frequency allocation. Because a node 101, generally, cannot be transmitting at the same time as it is receiving, dedicated timeslots for different nodes are needed.

The target node (e.g., node 101b of FIG. 1) selects an appropriate spreading code for the ACK or NACK message based on a predetermined scheme. As earlier described, this spreading code can be calculated from the beacon transmission order, determined from what is directly signaled in the original request, or calculated based on the information in the request. By way of example, the information that is used for selecting the correct spreading code include: source node number, target node number, message number, etc. In other words, when a node 101b decides to transmit a grant message, the node 101b selects a spreading code for positive acknowledgement based on agreed principles. Similarly, the node 101b selects a spreading code for negative acknowledgement.

The network 100 can employ a predefined rule for determining how nodes transmit SMRA messages. In an exemplary embodiment, the beacon transmission order selection for ACK transmissions may be based on the nodes MAC addresses. For instance, nodes 101 that have an even MAC address can transmit on even ACK opportunities, and nodes 101 with odd MAC addresses transmit on odd opportunities. In other embodiment, the nodes 101 negotiate the even and odd operation phases during the authentication and association phases. When node 101 is not transmitting in an opportunity the node 101 is receiving responses from other nodes 101.

Referring back to the transmission opportunity schemes I-III of FIGS. 4A and 4B, the resource request handshake delay can be significantly reduced. Additionally, this mechanism can be used to enhance other aspects of the MAC design, such as simple timeout mechanisms for resource reservation, and rapidly granting of the resource. These scenarios are depicted in FIG. 8B-8D, depending on which nodes are aware of interpretation of the ACK/NACK message.

As seen in FIG. 8B, Node A transmits a request (e.g., MSH-DSCH request) to Node B, as in step 811. Under this scenario, various nodes can utilize the ACK subchannel of a transmission frame, e.g., Frame 0, concurrently, by employing different spreading codes. Node B, along with Node A and Node C, transmits a negative acknowledgement of a grant (e.g., MSH-DSCH Grant NACK) (steps 813-817). In step 819, Node A receives negative acknowledgement messages from Nodes B and C.

In the example of FIG. 8C, Node A experiences a successful resource allocation from Node B. Using the beacon subframe of Frame 0, Node A sends a request to Node B, as in step 821. In step 823, Node B responds with a grant with the beacon subframe of Frame 1. Node A then confirms the grant, as in step 825, using the ACK subframe of Frame 1. In step 827, data is exchanged from Node A to Node B over the data frame of Frame 1.

The awareness of spectrum reservation of a node (e.g., node A) is different in 2-hop neighborhood of node A. FIG. 8D depicts a scenario in which transmission is started in the same frame as the original request. In step 831, Node A submits a request using the beacon subframe of Frame 0 to Node B, which then issues a grant within an ACK subframe of the same transmission frame, e.g., Frame 0 (step 833). Node A can also confirm the grant over this ACK subframe. Data transfer can subsequently be performed on the data frame of Frame 0.

If awareness in 2-hop neighborhood of the source node is needed, the granted reservation can be made public later on using beacon messages as depicted in FIG. 8E. First, Node A has a successful resource allocation using transmission frame Frame 0, per steps 841-847. In step 849, Node A notifies the neighboring nodes B, C and Z. The data transfer between Node A and Node B continues over other transmission frames, i.e., Frame 1 and Frame 2, per steps 851, 853.

One of ordinary skill in the art would recognize that the processes for providing shared reservation acknowledgement channel may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

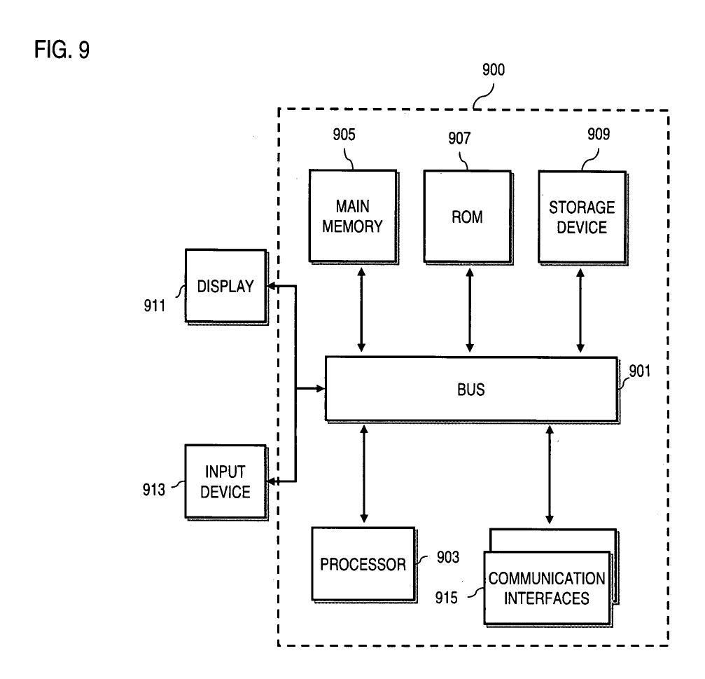

FIG. 9 illustrates exemplary hardware upon which various embodiments of the invention can be implemented. A computing system 900 includes a bus 901 or other communication mechanism for communicating information and a processor 903 coupled to the bus 901 for processing information. The computing system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computing system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computing system 900 may be coupled via the bus 901 to a display 911, such as a liquid crystal display, or active matrix display, for displaying information to a user. An input device 913, such as a keyboard including alphanumeric and other keys, may be coupled to the bus 901 for communicating information and command selections to the processor 903. The input device 913 can include a cursor control, such as a mouse, a trackball, or cursor direction keys, for communicating direction information and command selections to the processor 903 and for controlling cursor movement on the display 911.

According to various embodiments of the invention, the processes described herein can be provided by the computing system 900 in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 900 also includes at least one communication interface 915 coupled to bus 901. The communication interface 915 provides a two-way data communication coupling to a network link (not shown). The communication interface 915 sends and receives electrical, electromagnetic, or optical signals that carry digital data streams representing various types of information. Further, the communication interface 915 can include peripheral interface devices, such as a Universal Serial Bus (USB) interface, a PCMCIA (Personal Computer Memory Card International Association) interface, etc.

The processor 903 may execute the transmitted code while being received and/or store the code in the storage device 909, or other non-volatile storage for later execution. In this manner, the computing system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIGS. 10A and 10B are diagrams of an exemplary WiMAX (Worldwide Interoperability for Microwave Access) architecture, in which the system of FIG. 1 can operate, according to various exemplary embodiments of the invention. The architecture shown in FIGS. 10A and 10B can support fixed, nomadic, and mobile deployments and be based on an IP service model. Subscriber or mobile stations 1001 can communicate with an access service network (ASN) 1003, which includes one or more base stations 1005. In this exemplary system, the BS 1005, in addition to providing the air interface to the MS 1001, possesses such management functions as handoff triggering and tunnel establishment, radio resource management, quality of service (QoS) policy enforcement, traffic classification, DHCP (Dynamic Host Configuration Protocol) proxy, key management, session management, and multicast group management.

The base station 1005 has connectivity to an access network 1007. The access network 1007 utilizes an ASN gateway 1009 to access a connectivity service network (CSN) 1011 over, for example, a data network 1013. By way of example, the network 1013 can be a public data network, such as the global Internet.

The ASN gateway 1009 provides a Layer 2 traffic aggregation point within the ASN 1003. The ASN gateway 1009 can additionally provide intra-ASN location management and paging, radio resource management and admission control, caching of subscriber profiles and encryption keys, AAA client functionality, establishment and management of mobility tunnel with base stations, QoS and policy enforcement, foreign agent functionality for mobile IP, and routing to the selected CSN 1011.

The CSN 1011 interfaces with various systems, such as application service provider (ASP) 1015, a public switched telephone network (PSTN) 1017, and a Third Generation Partnership Project (3GPP)/3GPP2 system 1019, and enterprise networks (not shown).

The CSN 1011 can include the following components: Access, Authorization and Accounting system (AAA) 1021, a mobile IP-Home Agent (MIP-HA) 1023, an operation support system (OSS)/business support system (BSS) 1025, and a gateway 1027. The AAA system 1021, which can be implemented as one or more servers, provide support authentication for the devices, users, and specific services. The CSN 1011 also provides per user policy management of QoS and security, as well as IP address management, support for roaming between different network service providers (NSPs), location management among ASNs.

FIG. 10B shows a reference architecture that defines interfaces (i.e., reference points) between functional entities capable of supporting various embodiments of the invention. The WiMAX network reference model defines reference points: R1, R2, R3, R4, R5, R6, and R8. R1 is defined between the MS 101 and the ASN 1003a; this interface, in addition to the air interface, includes protocols in the management plane. R2 is provided between the MS 101 and an CSN (e.g., CSN 1011a and 1011b) for authentication, service authorization, IP configuration, and mobility management. The ASN 1003a and CSN 1011a communicate over R3, which supports policy enforcement and mobility management.

R4 is defined between ASNs 1003a and 1003b to support inter-ASN mobility. R5 is defined to support roaming across multiple NSPs (e.g., visited NSP 1029a and home NSP 1029b). R6 is defined between base stations 1005 and ASN-GWs 1009, and R8 is defined between base stations 1005.

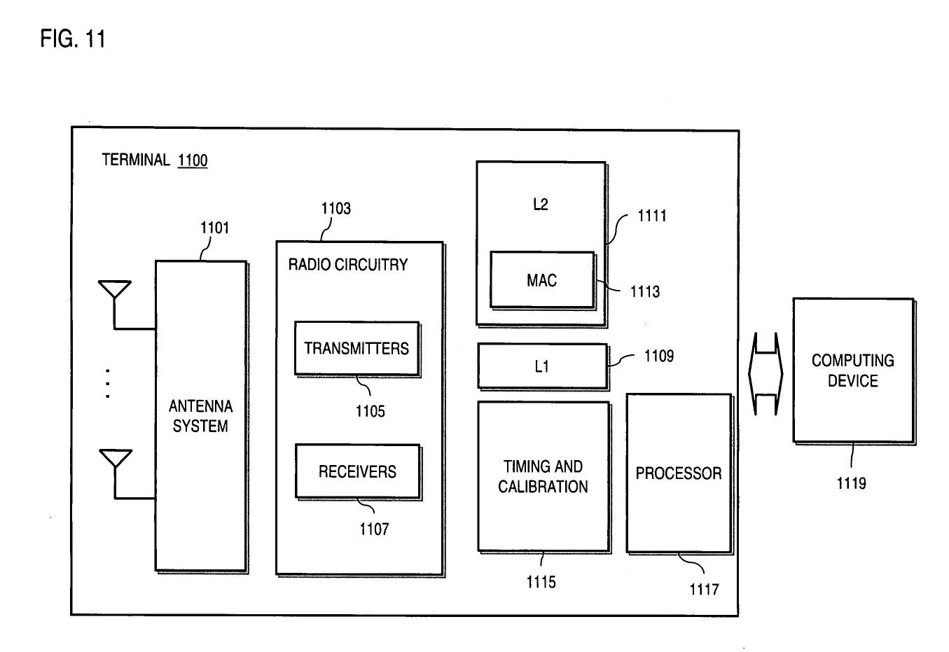

FIG. 11 is a diagram of exemplary components of a user terminal, according to an embodiment of the invention. A user terminal 1100 includes an antenna system 1101 (which can utilize multiple antennas) to receive and transmit signals. The antenna system 1101 is coupled to radio circuitry 1103, which includes multiple transmitters 1105 and receivers 1107. The radio circuitry encompasses all of the Radio Frequency (RF) circuitry as well as base-band processing circuitry. As shown, layer-1 (L1) and layer-2 (L2) processing are provided by units 1109 and 1111, respectively. Optionally, layer-3 functions can be provided (not shown). L2 unit 1111 can include module 1113, which executes all Medium Access Control (MAC) layer functions. A timing and calibration module 1115 maintains proper timing by interfacing, for example, an external timing reference (not shown). Additionally, a processor 1117 is included. Under this scenario, the user terminal 1100 communicates with a computing device 1119, which can be a personal computer, work station, a Personal Digital Assistant (PDA), web appliance, cellular phone, etc.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
generating a request for resource allocation from a neighboring node within a network; and
inserting the request in a beaconing subframe of a transmission frame, the transmission frame includes a reservation subframe that provides acknowledgement signaling relating to a grant of the resource allocation.

2. A method according to claim 1, further comprising:
transmitting the request to the neighboring node; and
listening to the reservation subframe for an acknowledgement or negative acknowledgement.

3. A method according to claim 2, wherein the reservation subframe includes a plurality of signaling opportunities for specifying the acknowledgement or the negative acknowledgement.

4. A method according to claim 3, wherein the signaling opportunities are further used to relay an acknowledgement or negative acknowledgement from another neighboring node.

5. A method according to claim 1, wherein the network includes a plurality of nodes including the neighboring node, the nodes being identified according to unique addresses, and the signaling opportunities being utilized according to whether the addresses are even or odd.

6. A method according to claim 1, wherein the addresses include Medium Access Control (MAC) addresses.

7. A method according to claim 1, wherein spreading codes are used to separate acknowledgement messages.

8. A method according to claim 1, wherein a beaconing period associated with the beaconing subframe is provided after an acknowledgement subframe corresponding to the reservation subframe.

9. A computer-readable storage medium carrying one or more sequences of one or more instructions which, when executed by one or more processors, cause the one or more processors to perform the method of claim 1.

10. An apparatus comprising:
a resource allocation module configured to generate a request for resource allocation from a neighboring node within a network, and to insert the request in a beaconing subframe of a transmission frame,
wherein the transmission frame includes a reservation subframe that provides acknowledgement signaling relating to a grant of the resource allocation.

11. An apparatus according to claim 10, further comprising:
a transceiver configured to transmit the request to the neighboring node, and to listen to the reservation subframe for an acknowledgement or negative acknowledgement.

12. An apparatus according to claim 11, wherein the reservation subframe includes a plurality of signaling opportunities for specifying the acknowledgement or the negative acknowledgement.

13. An apparatus according to claim 12, wherein the signaling opportunities are further used to relay an acknowledgement or negative acknowledgement from another neighboring node.

14. An apparatus according to claim 10, wherein the network includes a plurality of nodes including the neighboring node, the nodes being identified according to unique addresses, and the signaling opportunities being utilized according to whether the addresses are even or odd.

15. An apparatus according to claim 10, wherein the addresses include Medium Access Control (MAC) addresses.

16. An apparatus according to claim 10, wherein spreading codes are used to separate acknowledgement messages.

17. An apparatus according to claim 10, wherein a beaconing period associated with the beaconing subframe is provided after an acknowledgement subframe corresponding to the reservation subframe.

18. A method comprising:
receiving a request from a neighboring node within a network for resource allocation, wherein the request is transmitted within a beaconing subframe of a transmission frame that includes a reservation subframe; and
granting or rejecting the request using the reservation subframe to indicate an acknowledgement or negative acknowledgement relating to the grant or the rejection,
wherein the reservation subframe includes a plurality of signaling opportunities for specifying the acknowledgement or the negative acknowledgement, and the signaling opportunities are further used to relay an acknowledgement or negative acknowledgement from another neighboring node.

19. A method according to claim 18, further comprising:
determining a spreading code to represent either an acknowledgement message or a negative acknowledgement message based on a predetermined scheme.

20. A method according to claim 18, wherein the predetermined scheme includes,
calculating the spreading code based on beacon transmission order,
determined from what is directly signaled in the request, or
calculated from information in the request.

21. A method according to claim 18, wherein the network includes a plurality of nodes including the neighboring node, the nodes being identified according to Medium Access Control (MAC) addresses, and the signaling opportunities being utilized according to whether the addresses are even or odd.

22. A computer-readable storage medium carrying one or more sequences of one or more instructions which, when executed by one or more processors, cause the one or more processors to perform the method of claim 18.

23. An apparatus comprising:
a resource allocation module configured to receive a request from a neighboring node within a network for resource allocation, wherein the request is transmitted within a beaconing subframe of a transmission frame that includes a reservation subframe,
wherein the resource allocation module is further configured to grant or reject the request using the reservation subframe to indicate an acknowledgement or negative acknowledgement relating to the grant or the rejection,
wherein the reservation subframe includes a plurality of signaling opportunities for specifying the acknowledgement or the negative acknowledgement, and the signaling opportunities are further used to relay an acknowledgement or negative acknowledgement from another neighboring node.

24. An apparatus according to claim 23, wherein the resource allocation module is further configured to determine a spreading code to represent either an acknowledgement message or a negative acknowledgement message based on a predetermined scheme.

25. An apparatus according to claim 23, wherein the predetermined scheme includes,
calculating the spreading code based on beacon transmission order,
determined from what is directly signaled in the request, or
calculated from information in the request.

26. An apparatus according to claim 23, wherein the network includes a plurality of nodes including the neighboring node, the nodes being identified according to Medium Access Control (MAC) addresses, and the signaling opportunities being utilized according to whether the addresses are even or odd.
